(19) United States
(12) Patent Application Publication
(10) Pub. No.: US 2023/0334994 A1
(43) Pub. Date: Oct. 19, 2023

(54) Multi-Objective Collaborative Optimization Approach for Large- Scale Air Traffic Management

(71) Applicant: Beihang University, Beijing (CN)

(72) Inventors: Wenbo DU, Beijing (CN); Tong Guo, Beijing (CN); Yong Zhao, Beijing (CN); Junfeng Ni, Beijing (CN)

(73) Assignee: Beihang University, Beijing (CN)

(21) Appl. No.: 18/295,037

(22) Filed: Apr. 3, 2023

(30) Foreign Application Priority Data
Apr. 13, 2022 (CN) 202210383583.5

(51) Int. Cl. G08G 5/00

(52) U.S. Cl. CPC G08G 5/0039; G08G 5/0017; G06Q 50/30

(57) ABSTRACT

The present application relates to a multi-objective collaborative optimization approach for large-scale air traffic management, which belongs to the technical field of civil aviation management. The present application includes generating a delay time vector and a first delay time for each flight; grouping all the flights to get multiple flight groups based on the overlap of flight times; using a delay time vector of each flight in each flight group to generate a subspecies group, crossing each subspecies group to generate children in turn, obtaining a delay variable of each flight and make mutation, and after multiple evolutions, taking a solution as the second delay time of the corresponding flight, updating the first delay time of each flight to the second delay time, and the first delay time obtained after several cycles is used to control the departure time of the corresponding flight.

### CROSS-REFERENCE TO RELATED APPLICATIONS

This application claims priority to Chinese Patent Application No. 202210383583.5, filed on Apr. 13, 2022, which is hereby incorporated by reference in its entireties.

### TECHNICAL FIELD

The present application relates to the technical field of civil aviation management, in particular to a multi-objective collaborative optimization approach for large-scale air traffic management.

### BACKGROUND ART

With the continuous development of the aviation industry and the gradual increase of aviation flight demand, the congestion of the existing airspace and the probability of conflicts between flights also increase, causing serious security threats as well as flight delays. When resolving flight conflicts, flight delays may inevitably occur, and minimizing flight delays may increase the probability of conflicts. The problem is essentially an optimization problem with two conflicting goals.

In the past, many researchers have conducted systematic research on this problem, mainly focusing on the single objective mathematical programming formula. The basic 0-1 integer programming model was proposed in 1998, which aims to minimize flight delays under the constraints of airport capacity and department capacity by optimizing the time slots for flight departure and arrival. It should be noted that airspace congestion and flight conflict are often caused by a variety of factors, such as flight routes, traffic density, etc., which are difficult to describe with linear functions. With the increasing scale of the problem and the complexity of the objective function, traditional mathematical methods are not suitable for solving such problems, and it is difficult to adapt to the requirements of the actual situation.

Genetic algorithm (GA), a stochastic optimization technique, can efficiently solve multi-objective and high-dimensional complex optimization problems by using heuristic algorithms. In recent years, coevolutionary methods have been successfully applied to such problems. The main idea is to adopt a random grouping strategy to randomly divide the variables of large-scale problems into equal groups, to divide the problem into several sub-components for divide and conquer. The key step in this idea is the decomposition method of the problem, such as random grouping, or decomposing the n-dimensional problem into two n/2-dimensional problems to solve them recursively. However, when the variables of the problem are interactive, the grouping method still needs to be improved. For many flights, due to the complexity of the interaction between them, the random grouping strategy is not very appropriate, so it is necessary to explore new grouping schemes under the constraint of satisfaction.

### SUMMARY OF THE DISCLOSURE

Given the above analysis, the embodiment of the present application aims to provide a multi-objective collaborative optimization approach for large-scale air traffic management, so as to solve the problems of inappropriate existing grouping strategies and not considering multi-objective collaborative optimization.

The embodiment of the present application provides a multi-objective collaborative optimization approach for large-scale air traffic management, including the following steps:
obtain flight data, and generate delay time vector and first delay time for each flight;
update the departure time and arrival time of each flight according to the first delay time of each flight, and obtain flight conflict information by detecting flight conflicts at each time; according to the flight time overlap of any two flights, all flights are grouped to obtain multiple flight groups;
generate a subspecies according to the delay time vector of each flight in each flight group, cross-generate children for each subspecies in turn through a fast genetic algorithm, obtain the delay variable of each flight according to the flight conflict information, and perform mutation based on the delay variable to complete a genetic evolution, and obtain the optimized subspecies after multiple evolutions;
take the solution with the largest fitness in each optimized subspecies as the second delay time of the corresponding flight, update the first delay time of each flight to the second delay time, update the departure time and arrival time of each flight again, detect flight conflicts, group and genetic evolution, and update the first delay time; the first delay time obtained after multiple cycles is used to regulate the departure time of the corresponding flight.

Based on the further improvement of the above method, the flight conflict information obtained by detecting the flight conflict at each time includes:
based on the condition that the flight altitude and speed of each flight are the same, the flight path is divided at a fixed time interval, and the state vector of each flight at each time is obtained; according to the state vector of each flight, identify whether any two flights have flight conflicts at each time in turn, and obtain flight conflict information, including the total number of conflicts at each time and the total number of conflicts for each flight.

Based on the further improvement of the above method, the state vector of each flight at each time includes abscissa and ordinate, flight altitude, and corresponding time;
according to the state vector of each flight, the method sequentially identifies whether any two flights have flight conflicts at each time, including:
based on each time, the square of the difference between the abscissa and the ordinate of any two flights is added and then the square is derived to obtain the separation distance;
if the interval distance is less than the distance threshold, flight conflict will occur between the corresponding two flights; otherwise, flight conflict will not occur.

Based on the further improvement of the above method, according to the overlapping degree of flight time of any two flights, a plurality of flight groups can be obtained by grouping, including:
rank all flights based on flight data, and add the first flight to the first flight crew;
starting from the second flight, take one flight as the current flight, calculate the intersection of the flight time segments of the current flight and the remaining flights, and obtain the flight with the largest intersection length as the flight to be grouped;
if the flight to be grouped has been added to a flight group, the current flight will be added to the same flight group as the flight to be grouped; otherwise, a new flight group will be created, and the current flight will be added to the new flight group;
until all flights have joined a flight group and the grouping ends, multiple flight groups can be obtained.

Based on the further improvement of the above method, the delay time vector of each flight is based on {0, ts, 2×ts, 3×ts, . . . , δmax} as the selection range of delay time, randomly select S times from them to get the delay time vector pᵢ=(δ₁ⁱ, δ₂ⁱ, . . . , δ_{S}ⁱ), where 1≤i≤N, N is the total number of flights in the flight data, ts is the sampling time, δₘₐₓ is the maximum flight delay time and can be divided by ts.

Based on the further improvement of the above method, the method generates a subspecies according to the delay time vector of each flight in each flight group, including taking the delay time vector of each flight in each flight group as each row of the matrix, taking the delay time of the same column of each flight as a chromosome of the current subspecies, and taking each delay time as a gene.

Based on the further improvement of the above method, the delay variable of each flight is obtained according to the flight conflict information, including:
based on the total number of conflicts at each time in the flight conflict information, the maximum slope value, the minimum slope value, and the slope value at each time are obtained according to the difference between the total number of conflicts at each adjacent time;
according to the flight corresponding to each gene on the chromosome during genetic evolution, as the flight to be mutated, the slope value of the flight to be mutated at the corresponding time is obtained according to the updated departure time of the flight to be mutated;
if the slope value of the flight to be mutated is less than 0, the delay variable of the flight to be mutated is the inverse of the ratio of the slope value of the flight to be mutated to the minimum slope value; Otherwise, the delay variable of the flight to be mutated is the ratio of the slope value of the flight to be mutated to the maximum slope value.

Based on the further improvement of the above method, the mutation based on the delay variable includes:
obtain the maximum total number of conflicts according to the total number of conflicts of each flight in the current subspecies group;
in the range of less than or equal to the maximum total number of conflicts, randomly select the conflict threshold;
estimate in turn whether the total number of conflicts of the flight to be mutated corresponding to the current gene is greater than the conflict threshold; if it is greater, obtain the mutation value according to the delay variable of the flight to be mutated, and update the current gene value to the mutation value; otherwise, the current gene value remains unchanged.

Based on the farther improvement of the above method, the sudden change value is obtained according to the delay variable of the flight to be changed, including:
when the delay variable of the flight to be mutated is greater than rand(0,1), a value within the range of the current gene is randomly selected as the mutation value;
when the delay variable of the flight to be mutated is less than −rand(0,1), a value within the range of the current gene and the maximum flight delay time is randomly selected as the mutation value;
when the delay variable of the flight to be mutated meets other conditions, a value shall be randomly selected within the range of the maximum flight delay time or less as the mutation value.

Based on the further improvement of the above method, the fitness is calculated according to the following formula:

$${Fitness}_{k}^{( l )} = \frac{1 - \frac{1}{{m}_{k}} {\sum }_{j = 1}^{{m}_{k}} \frac{{δ}_{1}^{( l )}}{{δ}_{max}}}{1 + \frac{1}{2} {\sum }_{j = 1}^{{m}_{k}} {NC}_{kj}}$$

wherein, Fitnessₖ^{(l)} is the fitness of the first chromosome in the k-th subspecies group, and mₖ is the total number of flights in the k-th subspecies group; δₘₐₓ is the maximum flight delay time, which δₗ^{(j)} is the j-th gene of the first chromosome in the k-th subspecies, and NCₖⱼ is the total number of conflicts of flights corresponding to the j-th gene in the k-th subspecies.

Compared with the prior art, the present application can achieve at least one of the following beneficial effects:
1. Based on the situation of a large number of flights, staggered periods, and complex routes, and aiming at the optimization requirements of flight conflicts and delays, a regulation scheme is designed using the idea of dynamic grouping and co-evolution, in which the dynamic grouping method is based on the time overlap of flights, so that highly coupled flights can participate in the optimization as a whole, and maximize the optimization of flights with interactions into a group, so as to reduce the risk of early convergence; co-evolution reasonably decomposes the original high dimension optimization problem into several low dimension optimization problems for centralized solution, obtaining high-quality solutions, and realizing the dual optimization of flight conflict and delay.
2. By using time overlap degree grouping, only two flights need to calculate and sort overlapping periods, which greatly reduces the time required for grouping and improves the speed of each round of calculation.
3. A mutation operator combined with the local search mechanism is adopted, which can make a mutation meeting a certain trend near the original value, playing the effect of “peak clipping and valley filling”, making the distribution of conflicts more balanced, facilitating the next round of optimization, and thus reducing conflicts.

In the present application, the above technical solutions can also be combined to achieve more preferred combination solutions. Other features and advantages of the present application will be outlined in a subsequent specification, and some of the advantages may become apparent from the specification or may be understood by the implementation of the present application. The object and other advantages of the present application can be realized and obtained through the description and the contents specially indicated in the drawings.

### BRIEF DESCRIPTION OF DRAWINGS

The drawings are only to show specific embodiments and are not considered as a limitation of the present application. In the whole drawings, the same reference symbols represent the same components.

FIG. 1 is the flow chart of the multi-objective collaborative optimization approach for large-scale air traffic management in Embodiment 1 of the present application;

FIG. 2 shows the flight route and conflict in Embodiment 1 of the present application;

FIG. 3 is a diagram of conflict detection based on state vector comparison in Embodiment 1 of the present application;

FIG. 4 is the flow chart of flight grouping based on time of flight overlap in Embodiment 1 of the present application;

FIG. 5 is a diagram showing the change in the total number of flight conflicts with time in Embodiment 1 of the present application;

FIG. 6 is a comparison diagram of the implementation effect of the flight control method in Embodiment 2 of the present application.

### DETAILED DESCRIPTION OF THE DISCLOSURE

The preferred embodiments of the present application are described in detail below in combination with the accompanying drawings. The accompanying drawings form part of the application and, together with the embodiments of the present application, are used to explain the principle of the present application, not to limit the scope of the present application.

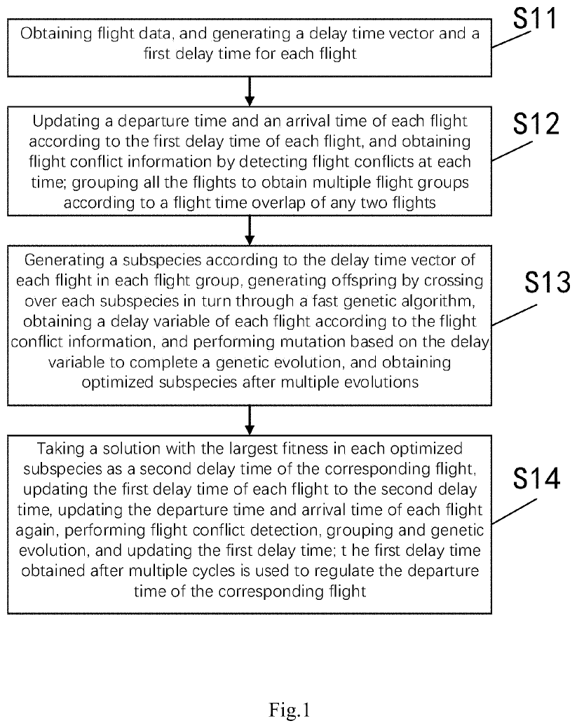

A specific embodiment of the present application discloses a multi-objective collaborative optimization approach for large-scale air traffic management. In this method, first, the conflict situation of each flight is obtained according to flight information, and then, each flight is dynamically grouped according to the overlap of takeoff and landing times between flights, to achieve the division and conquer of the original problem; Secondly, a fast genetic algorithm is used to cross and mutate chromosomes in the corresponding subspecies of each grouping, and fitness selection is conducted at the gene level. When the subpopulation evolution reaches a certain algebra, the method of fitness evaluation of chromosomes is used to select the optimal solution of each subpopulation, and further merge it into the optimal solution of the original problem. Under the premise of reasonable divide and conquer, the conflict and delay of each flight are weighed to optimize the flight takeoff time slot. As shown in FIG. 1, the method includes the following steps:
S11: Obtain flight data, and generate a delay time vector and a first delay time for each flight;

It should be noted that the obtained flight data include: flight number, departure time, arrival time, delay time, departure airport coordinates, landing airport coordinates, and flight path. The maximum flight delay time δmax of all flights in the flight data can be obtained through statistics.

According to the sampling time ts of flight data, the delay time vector is generated for each flight, which is composed of multiple times with the same number randomly selected and divisible by the sampling time within the range of less than or equal to the maximum flight delay time.

Specifically, take {0, ts, 2×ts, 3×ts, . . . , δmax} as the selection range of delay time, select one of δmax/ts+1 times randomly and repeat for S times to get the delay time vector pᵢ=(δ₁ⁱ, δ₂ⁱ, . . . , δ_{S}ⁱ) of flight Fᵢ. Where, l≤i≤N, N is the total number of flights in the flight data, δₘₐₓ can be divided by ts, 80≤S≤100, and can be randomly selected multiple times at the same time.

For example, ts is 0.5 minutes, δₘₐₓ is 90 minutes, and S is 80.

The initial setting of the first delay time of each flight is 0, which is continuously updated through the subsequent steps. The final first delay time is used to regulate the departure time of the corresponding flight to optimize the flight departure time slot.
S12: Update the departure time and arrival time of each flight according to the first delay time of each flight, and obtain flight conflict information by detecting flight conflicts at each time; According to the flight time overlap of any two flights, all flights are grouped to obtain multiple flight groups;

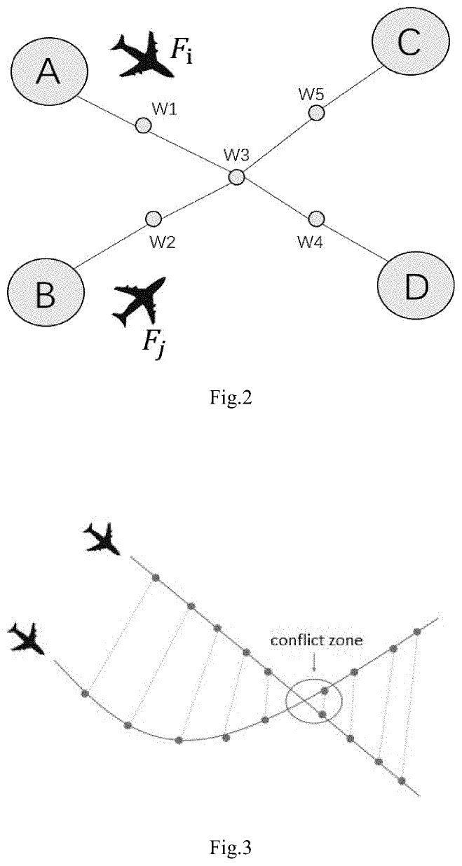

It should be noted that the protection area of aircraft in flight is defined as a cylindrical area with a radius of 5 nautical miles and a height of 2000 feet. When the protection areas of two flights overlap, a conflict will occur. FIG. 2 shows the flight route and conflict diagram. The flight route of flight Fᵢ is (A, W1, W3, W4, D), and that of flight Fⱼ is (B, W2, W3, W5, C). Assuming that two flights are flying at the same speed and the same altitude, W3 is a waypoint where a potential conflict occurs.

Update the departure time and arrival time of each flight, that is, add the corresponding first delay time to the departure time and arrival time of each flight.

Through the detection of flight conflicts at all times, the flight conflict information obtained includes:
\textcircled{1} Based on the condition that the flight altitude and speed of each flight are the same, the flight path is divided at a fixed time interval, and the state vector of each flight at each time is obtained.

It should be noted that the state vector includes the abscissa x and ordinate y on the horizontal plane, the flight height h, and the corresponding time t, expressed as (x, y, h, t). According to the flight path and takeoff time, the flight path is divided at a fixed time interval, and the corresponding state vector of each flight at each time can be obtained, for example, at an interval of 10 seconds.
\textcircled{2} According to the state vector of each flight, identify whether there is flight conflict between any two flights at each time, and obtain flight conflict information, including the total number of conflicts at each time and the total number of conflicts for each flight.

Specifically, according to the state vector of each flight, identify whether there is flight conflict between any two flights at each time, including:

Based on each time, the square of the difference between the abscissa and the ordinate of any two flights is added and then the square is derived to obtain the separation distance.

If the separation distance is less than the distance threshold, flight conflicts will occur between the corresponding two flights; otherwise, flight conflicts will not occur.

For example, when the flight altitude is h₀, the state vector of flight Fᵢ (xᵢ, yᵢ, h₀, t) and the state vector of flight Fⱼ (xⱼ, yⱼ, h₀, t) at time t, if \sqrt{(xᵢ−xⱼ)²+(yᵢ−yⱼ)²}<5 n mile, then it means that two flights will conflict, otherwise it will not. In FIG. 3, the points connected by dotted lines correspond to the same instant of time, and the part in the circle is the conflict area.

All flights detect flight conflicts in pairs at each time and finally get the total number of conflicts at each time and the total number of conflicts for each flight.

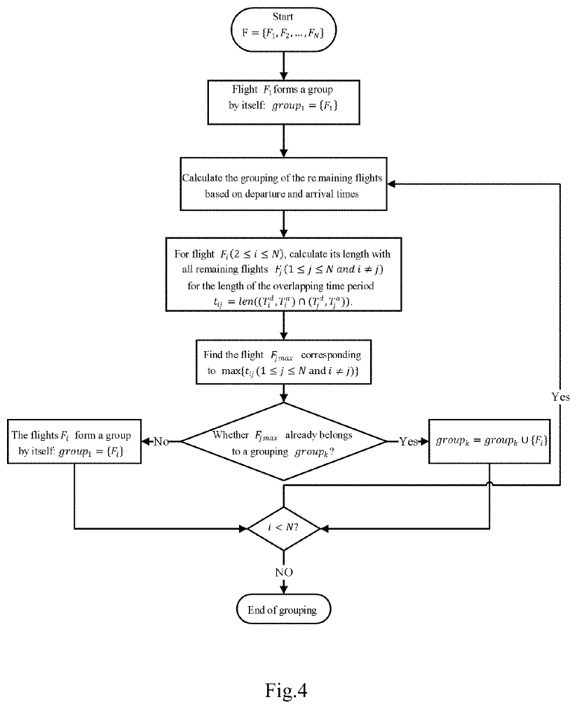

Then, dynamically group flights according to the overlapping degree of flight time to obtain multiple flight groups. The flow chart shown in FIG. 4, including:
\textcircled{1} Rank all flights based on flight data, and add the first flight to the first flight crew.

It should be noted that each flight in the flight data will identify the flight time overlap with other flights. Therefore, this embodiment does not limit the sorting method. For example, it can be sorted by flight number or departure time.
\textcircled{2} Starting from the second flight, take one flight as the current flight, calculate the intersection of the flight time segments of the current flight and the remaining flights, and obtain the flight with the largest intersection length as the flight to be grouped.

It should be noted that the overlap of flight time is expressed by the intersection length of flight time segments. Starting from flight F₂, calculate the length of the overlapping time segment between flight Fᵢ and the remaining flight Fⱼ (2≤i≤N, 1≤j≤N and j≠i, N and j≠i, N is the total number of flights). That is, find the intersection of the flight time segments of the two flights to obtain the time overlap between the two flights tᵢⱼ=len((Dᵢ,Aᵢ)∩(Dⱼ,Aⱼ)), where Dᵢ is the departure time after updating flight Fᵢ, Aᵢ is the arrival time after updating flight Fᵢ, and Dⱼ is the departure time after updating flight Fⱼ, Aⱼ is the updated arrival time of flight Fⱼ.

Each flight will form an N−1 corresponding time overlap with the remaining N−1 flights, and the Fⱼₘₐₓ of the two flights (Fⱼₘₐₓ,Fᵢ) corresponding to the maximum time overlap is the flight to be grouped.
\textcircled{3} If the flight to be grouped has been added to a flight group, add the current flight to the same flight group as the flight to be grouped; otherwise, create a new flight group and add the current flight to the new flight group;
\textcircled{4} Grouping ends until all flights have joined a flight group, multiple flight groups can be obtained.

Group according to the aircraft time overlap, so that each flight is divided into a group as far as possible with the flight with the largest time overlap. Time overlap means that flight conflicts may occur during this period. Therefore, this dynamic grouping is essential to dynamically divide the flights that may conflict into a group, so that the flights that interact with each other can be grouped for genetic evolution as a subspecies.

In addition, only two flights are needed to calculate and sort the overlapping time segments by using time overlap degree grouping, so its corresponding time complexity is O(N²), where N is the total number of flights. In the prior art, the time complexity of grouping according to the conflicted relationship is O(T×N²), where T is the time step of calculation conflict. It can be seen that grouping according to time overlap adopted in this embodiment greatly reduces the time required for grouping and improves the speed of each round of calculation.
S13: Generate a subspecies according to the delay time vector of each flight in each flight group, cross each subspecies, in turn, to generate children through a fast genetic algorithm, obtain delay variables of each flight according to flight conflict information, and perform mutation based on delay variables to complete a genetic evolution, and obtain the optimized subspecies after multiple evolutions.

It should be noted that for each flight group, genetic evolution is completed through steps S131-S134.
S131: Construct subspecies and obtain chromosomes.

Specifically, the delay time vector of each flight in each flight group is formed into a subspecies group, including taking the delay time vector of each flight in each flight group as each row of the matrix, taking the delay time of the same column of each flight as a chromosome of the current subspecies group, and taking each delay time as a gene.

For group k, groupₖ=(Fₖ⁽¹⁾, Fₖ⁽²⁾, . . . , Fₖ^{(m}^{ₖ}⁾), Fₖ^{(j)} (1≤j≤mₖ) is the j-th flight in group k, mₖ is the total number of flights in group k, and the subspecies subpopₖ corresponding to group k is expressed

as:

$${subpop}_{k} = ( \begin{matrix}{p}_{k}^{( 1 )} \\ {p}_{k}^{( 2 )} \\ ⋮ \\ {p}_{k}^{( {m}_{k} )}\end{matrix} ) = ( \begin{matrix}{δ}_{1}^{( 1 )} & {δ}_{2}^{( 1 )} & … & {δ}_{S}^{( 1 )} \\ {δ}_{1}^{( 2 )} & {δ}_{2}^{( 2 )} & … & {δ}_{S}^{( 2 )} \\ ⋮ & ⋮ & ⋮ & ⋮ \\ {δ}_{1}^{( {m}_{k} )} & {δ}_{2}^{( {m}_{k} )} & … & {δ}_{S}^{( {m}_{k} )}\end{matrix} ) = ( {f}_{k}^{( 1 )} , {f}_{k}^{( 2 )} , … , {f}_{k}^{( {m}_{k} )} )$$

Where, pₖ^{(j)} ((1≤j≤mₖ) is the delay time vector corresponding to the flight Fₖ^{(j)}, 2≤k≤sn, sn is the total number of subpopulations, fₖ^{(l)}=(δₗ⁽¹⁾, δₗ⁽²⁾, . . . , δₗ^{(m}^{ₖ}⁾) (1≤l≤S) is a chromosome, representing a possible solution, and δₗ^{(l)} is the first delay time in the delay time vector of the first flight in group k.
S132: cross over subspecies to generate offspring.

It should be noted that the fitness of the gene δₗ^{(j)} (1≤j≤mₖ) on the chromosome fₖ^{(l)} is:

$${fitness}_{kj}^{l} = \frac{1 - {δ}_{l}^{( j )} / {δ}_{max}}{1 + {NC}_{kj}} \qquad Formula ( 2 )$$

wherein, NCₖⱼ is the total number of conflicts of the j-th flight in the k group, that is, the total number of conflicts of the flights corresponding to the j-th gene in the k subspecies, δₘₐₓ is the maximum flight delay time.

This crossover method does not calculate the fitness of the whole chromosome but introduces the fitness of each gene in the chromosome. In the crossover process, it takes the reduction of ground delay and conflict of each flight into account. The parameters in the formula are determined at the beginning, which has the characteristics of quickly finding a better solution.

Chromosomes of the parent subspecies are randomly paired to produce two offspring chromosomes, of which the probability of crossover is c, 0.6≤c≤0.9, preferably, c=0.7. Randomly generate a number between (0, 1). If the number is less than c, it will cross. Otherwise, it will not cross.

When crossing, compare the alleles produced on the parent chromosome fₖ⁽¹¹⁾ and fₖ⁽¹²⁾, and select the offspring chromosome fₖ⁽¹³⁾ and fₖ⁽¹⁴⁾ the j-th gene in three cases, including:
\textcircled{1} when fitnessₖⱼ¹¹>fitnessₖⱼ¹², the j-th gene fₖ⁽¹¹⁾ of the chromosomes of the two generations is inherited from the j-th gene.
\textcircled{2} when fitnessₖⱼ¹¹>fitnessₖⱼ¹², the j-th gene fₖ⁽¹²⁾ of the chromosomes of the two generations is inherited from the j-th gene.
\textcircled{3} when fitnessₖⱼ¹¹=fitnessₖⱼ¹², the j-th gene on the chromosomes of the two offspring are:

δ₁₄^{(j)}=floor(0.5×[(1−γⱼ)δ₁₁^{(j)}+(1+γⱼ)δ₁₂^{(j)}]) Formula (3)

δ₁₄^{(j)}=floor(0.5×[(1−γⱼ)δ₁₁^{(j)}+(1+γⱼ)δ₁₂^{(j)}]) Formula (4)

Wherein, floor( ) is a function that rounds down,

$${γ}_{j} = \{ \begin{matrix}{( 2 {u}_{j} )}^{\frac{1}{\text{?}}} , {u}_{j} \leq 0.5 \\ {( \frac{1}{2 ( 1 - {u}_{j} )} )}^{\frac{1}{\text{?}}} , {u}_{j} > 0.5\end{matrix}$$

$$\text{?} \text{indicates text missing or illegible when filed}$$

and uⱼ∈U(0,1) is selected randomly, η>0 is a distribution index, preferably, η=Iₒ.

The crossover operator simulating binary single point crossover is used here, because γⱼ is dynamically and randomly determined, so this operator can jump out of the local optimal solution, has good global search ability, and has excellent performance for the sparse individual space of high-dimensional objective optimization problems.
S133: Acquisition of delayed variables, mutation occurring.

If crossing occurs in step S132, the newly generated offspring chromosome will be mutated; If no crossover occurs, the parent chromosome will be mutated directly.

Specifically, the delay variable of each flight obtained according to flight conflict information is used to mark whether the flight should take off early or be delayed. The acquisition methods include:
\textcircled{1} Based on the total number of conflicts at each time in the flight conflict information, the maximum slope value, the minimum slope value, and the slope value at each time are obtained according to the difference between the total number of conflicts at each adjacent time.

For example, the total number of conflicts at each time obtained in step S12 is plotted as a curve of the number of conflicts over time, as shown in FIG. 5, where the maximum slope value δₘₐₓ and the minimum slope value Kₘᵢₙ are marked.
\textcircled{2} According to the flight corresponding to each gene on the chromosome during genetic evolution, as the flight to be mutated, the slope value of the flight to be mutated at the corresponding time is obtained according to the updated departure time of the flight to be mutated.

For example, one gene on the chromosome corresponds to flight Fᵢ, and according to its updated takeoff time, the slope value Kᵢ is obtained in FIG. 5.
\textcircled{3} If the slope value of the flight to be changed is less than 0, the delay variable of the flight to be changed is the opposite of the ratio of the slope value of the flight to be changed to the minimum slope value; Otherwise, the delay variable of the flight to be changed is the ratio of the slope value of the flight to be changed to the maximum slope value.

Specifically, if the Fᵢ slope value Kᵢ of the flight to be mutated is less than 0, it means that the total number of overall conflicts of the corresponding flight is decreasing when the flight to be mutated takes off, then the delay variable flagᵢ=−Kᵢ/Kₘᵢₙ, otherwise, the delay variable flagᵢ=Kᵢ/Kₘᵢₙ.

Thus, the delay variable flagᵢ∈[−1,1].

Mutation based on delayed variables, including:
\textcircled{1} Obtain the maximum total number of conflicts according to the total number of conflicts of each flight in the current subspecies group;
\textcircled{1} In the range of less than or equal to the maximum total number of conflicts, randomly select the conflict threshold;

It should be noted that the conflict threshold NCₖₕ is randomly selected in [0, NCₖₘₐₓ] to determine whether mutation should occur. Among them, NCₖₘₐₓ is the maximum number of conflicts in group k flights, and NCₖₕ is the conflict threshold of group k.
\textcircled{3} Estimate in turn whether the total number of conflicts of the flight to be mutated corresponding to the current gene is greater than the conflict threshold. If it is greater, obtain the mutation value according to the delay variable of the flight to be mutated, and update the current gene value to the mutation value; Otherwise, the current gene value remains unchanged.

Specifically, the flight to be mutated corresponding to the current gene is flight Fᵢ, and the total number of conflicts is NCₖᵢ:

If NCₖᵢ>NCₖₕ, the total number of conflicts representing flight Fᵢ exceeds the conflict threshold, and mutation should occur. The mutation value is obtained according to the delay variable flagᵢ of flight Fᵢ including:
When the delay variable of the flight to be mutated is greater than rand(0,1), a value within the range of the current gene is randomly selected as the mutation value;
That is, when flagᵢ>rand(0,1), a value between [0, δₗ⁽ⁱ⁾] will be randomly selected as the new delay time of the flight, indicating that the flight should take off in advance. Wherein is the gene δₗ⁽ⁱ⁾ corresponding to the first chromosome of the i-th flight in group k, that is, the departure delay time.
When the delay variable of the flight to be mutated is less than −rand (0,1), a value within the range of the current gene and the maximum flight delay time is randomly selected as the mutation value.
That is, when flagᵢ<−rand(0,1), a value between [δₗ⁽ⁱ⁾, δₘₐₓ] will be randomly selected as the new delay time of the flight, indicating that the flight should be appropriately delayed.
When the delay variable of the flight to be mutated meets other conditions, a value shall be randomly selected within the range of the maximum flight delay time or less as the mutation value.
That is, for the rest of the cases, the delay variable of the flight is generated randomly in [0, δmax] with no tendency to advance or delay.

If NCₖᵢ≤NCₖₕ, the total number of conflicts representing flight Fᵢ does not exceed the conflict threshold, no mutation occurs, and the gene value does not change.

In the process of genetic mutation, considering the increase in the overall number of conflicts when a flight departs means that the flight should take off early to avoid the upcoming conflict peak: The reduction of the overall number of conflicts when a flight departs means that the flight can be appropriately delayed, which can further balance the number of conflicts and avoid conflict concentration. At the same time, the setting of the threshold makes the probability of the flight with more conflicts changing the delay time greater and having less impact on the flight with fewer conflicts, thus effectively affecting the takeoff arrangement of the flight with more conflicts. In general, the mutation operator has the effect of “peak clipping and valley filling” by making certain adjustments near the original value, making the distribution of conflicts more balanced, facilitating the next optimization, and thus reducing conflicts.
S134: Determine whether to continue genetic evolution according to evolution algebra.

Specifically, if the current evolution algebra is less than the maximum evolution algebra of the preset subspecies, then the evolution algebra is increased by 1, and the chromosome obtained in step S133 is used to form a population as a subspecies. Return to step S132 to start the crossover and mutation again. Otherwise, genetic evolution is completed for the current multiple flight groups, multiple optimized subspecies are obtained, and step S14 is executed. By way of example, the maximum evolutionary algebra of the subspecies is set as 80 generations.
S14: Take the solution with the largest fitness in each optimized subspecies as the second delay time of the corresponding flight, update the first delay time of each flight to the second delay time, update the departure time and arrival time of each flight again, detect, group and genetically evolve flight conflicts, and update the first delay time. The first delay time obtained after multiple cycles is used to regulate the departure time of the corresponding flight.

Specifically, each optimized subspecies selects the chromosome fₖ⁽ⁱ⁾ with the highest fitness from its chromosomes as the solution obtained by this iteration, where the fitness is calculated according to the following formula:

$${Fitness}_{k}^{( l )} = \frac{1 - \frac{1}{{m}_{k}} {\sum }_{j = 1}^{{m}_{k}} \frac{{δ}_{1}^{( l )}}{{δ}_{max}}}{1 + \frac{1}{2} {\sum }_{j = 1}^{{m}_{k}} {NC}_{kj}} \qquad Formula ( 5 )$$

Wherein, Fitnessₖ^{(l)} is the fitness of the first chromosome in the k-th subspecies group, and mₖ is the total number of flights in the k-th subspecies group; δₘₐₓ is the maximum flight delay time, which δₗ^{(j)} is the j-th gene of the first chromosome in the k-th subspecies, and NCₖⱼ is the total number of conflicts of flights corresponding to the j-th gene in the k-th subspecies.

Each gene value on the chromosome with the largest fitness is the latest delay time of the corresponding flight as the second delay time, and the first delay time of each flight is updated to the second delay time. If the current population evolution algebra is less than the preset population maximum evolution algebra, then the population evolution algebra is increased by 1, return, and perform steps S12 and S13 again for flight conflict detection, grouping, and genetic evolution; On the contrary, the optimization and regulation process is completed, and the first delay time finally obtained is used to regulate the departure time of the corresponding flight.

It should be noted that to ensure the stability of the solution obtained, a larger evolution algebra can be used. Preferably, the overall maximum evolution algebra is set to 800 generations.

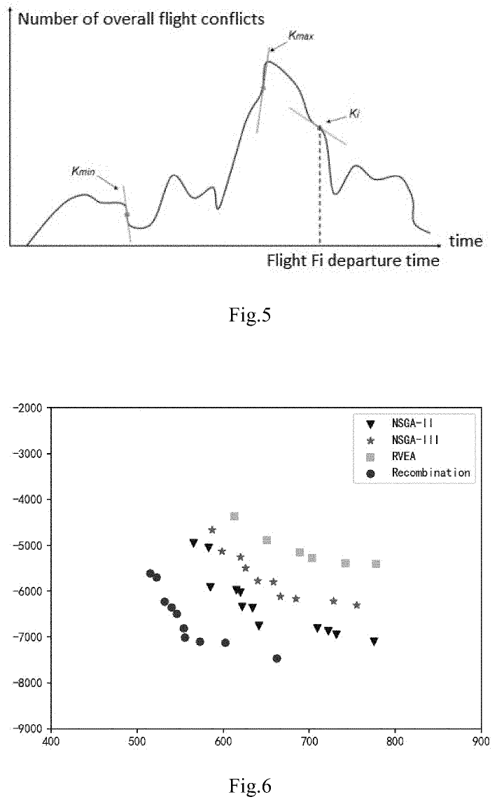

Based on the national air traffic flow data from 9:00 a.m. to 12:00 a.m. on Oct. 1, 2018, the flight data are obtained. The traditional NSGA-II, NSGA-III, RVEA algorithms, and the regulation algorithm in this embodiment are used respectively to obtain the results, which are shown in FIG. 6. In FIG. 6, the abscissa represents the total number of conflicts, and the ordinate represents the deviation between arrival at the destination and the planned time. It can be seen that the number of conflicts and the delay time is significantly reduced through the regulation scheme of this embodiment (the Recognition algorithm represented by dots).

Compared with the prior art, a multi-objective collaborative optimization approach for large-scale air traffic management provided in this embodiment is a regulatory scheme designed by using the idea of dynamic grouping and co-evolution to meet the optimization requirements of flight conflict and delay. By using time overlap grouping, the time required for grouping is greatly reduced, and the speed of each round of calculation is improved. It also enables highly coupled flights to participate in optimization as a whole, and maximizes the grouping of flight optimization with interactions to reduce the risk of early convergence; co-evolution reasonably decomposes the original high-dimension optimization problem into several low-dimension optimization problems for a centralized solution. It adopts a mutation operator combined with a local search mechanism, which can perform mutation near the original value to meet a certain trend. It has the effect of “cutting peak and filling valley”, making the distribution of conflicts more balanced, thereby reducing conflicts and obtaining high-quality solutions, double optimization of flight conflict and delay is realized.

Those skilled in the art can understand that all or part of the process of realizing the above embodiment method can be completed by instructing the relevant hardware through a computer program, and the program can be stored in a computer-readable storage medium. Wherein, the computer-readable storage medium is a disk, optical disk, read-only storage memory or random storage memory, etc.

The above description is only a better specific embodiment of the present application, but the scope of protection of the present application is not limited to this. Any change or replacement that can easily be thought of by any person familiar with the technical field within the scope of the disclosed technology of the present application should be included in the scope of protection of the present application.

What is claimed is:

1. A multi-objective collaborative optimization approach for large-scale air traffic management, comprising:
obtaining flight data, and generating a delay time vector and a first delay time for each flight;
updating a departure time and an arrival time of each flight according to the first delay time of each flight, and obtaining flight conflict information by detecting flight conflicts at each time; grouping all the flights to obtain multiple flight groups according to a flight time overlap of any two flights;
generating a subspecies according to the delay time vector of each flight in each flight group, generating offspring by crossing over each subspecies in turn through a fast genetic algorithm, obtaining a delay variable of each flight according to the flight conflict information, and performing mutation based on the delay variable to complete a genetic evolution, and obtaining optimized subspecies after multiple evolutions;
taking a solution with the largest fitness in each optimized subspecies as a second delay time of the corresponding flight, updating the first delay time of each flight to the second delay time, updating the departure time and arrival time of each flight again, performing flight conflict detection, grouping and genetic evolution, and updating the first delay time; the first delay time obtained after multiple cycles is used to regulate the departure time of the corresponding flight.

2. The large-scale flight control method based on multi-objective collaborative optimization according to claim 1, wherein obtaining flight conflict information by detecting flight conflicts at each time specifically comprises:
based on the condition that the flight altitude and speed of each flight are the same, the flight path is divided at a fixed time interval, and a state vector of each flight at each time is obtained; according to the state vector of each flight, identifying whether any two flights have flight conflicts at each time in turn, and obtaining flight conflict information, including the total number of conflicts at each time and the total number of conflicts for each flight.

3. The large-scale flight control method based on multi-objective collaborative optimization according to claim 2, wherein the state vector of each flight at each time comprises abscissa and ordinate, flight height, and corresponding time;
according to the state vector of each flight, the method sequentially identifies whether any two flights have flight conflicts at each time, which specifically comprises:
based on each time, a square of the difference between the abscissa and the ordinate of any two flights is added and then the square is derived to obtain the separation distance;
if the interval distance is less than the distance threshold, flight conflict will occur between the corresponding two flights; otherwise, flight conflict will not occur.

4. The large-scale flight control method based on multi-objective collaborative optimization according to claim 3, wherein the method of obtaining multiple flight groups by grouping according to the flight time overlap of any two flights specifically comprises:
ranking all flights based on flight data, and adding the first flight to the first flight crew;
starting from the second flight, taking one flight as the current flight, calculating the intersection of the flight time segments of the current flight and the remaining flights, and obtaining the flight with the largest intersection length as the flight to be grouped;
if the flight to be grouped has been added to a flight group, the current flight will be added to the same flight group as the flight to be grouped; otherwise, a new flight group will be created, and the current flight will be added to the new flight group;
grouping is officially ended until all flights have joined a flight group and multiple flight groups are obtained.

5. The large-scale flight control method based on multi-objective collaborative optimization according to claim 4, wherein the delay time vector of each flight is based on {0, ts, 2×ts, 3×ts, . . . , δmax} as a selected range of delay time, randomly selecting S times from them to get a delay time vector A pᵢ=(δ₁ⁱ, δ₂ⁱ, . . . , δ_{S}ⁱ), where 1≤i≤N, N is the total number of flights in the flight data, ts is the sampling time, δₘₐₓ is the maximum flight delay time and can be divided by ts.

6. The large-scale flight control method based on multi-objective collaborative optimization according to claim 5, wherein generating a subspecies according to the delay time vector of each flight in each flight group comprises: taking the delay time dimension of each flight in each flight group as each row of the matrix, taking the delay time of the same column of each flight as a chromosome of the current subspecies group, and taking each delay time as a gene.

7. The large-scale flight control method based on multi-objective collaborative optimization according to claim 6, wherein obtaining the delay variable of each flight according to the flight conflict information comprises:
based on the total number of conflicts at each time in the flight conflict information, a maximum slope value, a minimum slope value, and a slope value at each time are obtained according to the difference between the total number of conflicts at each adjacent time;
in the process of genetic evolution, a corresponding flight of each gene on the chromosome is regarded as the flight to be mutated; the slope value of the flight to be mutated at the corresponding time is obtained according to the updated departure time of the flight to be mutated;
if the slope value of the flight to be mutated is less than 0, the delay variable of the flight to be mutated is the inverse of a ratio of the slope value of the flight to be mutated to the minimum slope value; otherwise, the delay variable of the flight to be mutated is a ratio of the slope value of the flight to be mutated to the maximum slope value.

8. The large-scale flight control method based on multi-objective collaborative optimization according to claim 7, wherein performing mutation based on the delay variable specifically comprises:
obtaining the maximum total number of conflicts according to the total number of conflicts of each flight in the current subspecies group;
in the range of less than or equal to the maximum total number of conflicts, randomly selecting the conflict threshold;
determining in turn whether the total number of conflicts of the flight to be mutated corresponding to the current gene is greater than the conflict threshold; if it is greater, obtain the mutation value according to the delay variable of the flight to be mutated, and update the current gene value to the mutation value; otherwise, the current gene value remains unchanged.

9. The large-scale flight control method based on multi-objective collaborative optimization according to claim 8, wherein obtaining the mutation value according to the delay variable of the flight to be mutated specifically comprises:
when the delay variable of the flight to be mutated is greater than rand(0,1), a value within the range of the current gene is randomly selected as the mutation value;
when the delay variable of the flight to be mutated is less than −rand(0,1), a value within the range of the current gene, and the maximum flight delay time is randomly selected as the mutation value;
when the delay variable of the flight to be mutated meets other conditions, a value shall be randomly selected within the range of the maximum flight delay time or less as the mutation value.

10. The large-scale flight control method based on multi-objective collaborative optimization according to claim 9, wherein fitness is calculated according to the following formula:
$${Fitness}_{k}^{( l )} = \frac{1 - \frac{1}{{m}_{k}} {\sum }_{j = 1}^{{m}_{k}} \frac{{δ}_{1}^{( l )}}{{δ}_{max}}}{1 + \frac{1}{2} {\sum }_{j = 1}^{{m}_{k}} {NC}_{kj}}$$
wherein, Fitnessₖ^{(l)} is the fitness of the first chromosome in the k-th subspecies group, and mₖ is the total number of flights in the k-th subspecies group; δₘₐₓ is the maximum flight delay time, which is the j-th gene of the first chromosome in the k-th subspecies, and NCₖⱼ is the total number of conflicts of flights corresponding to the j-th gene in the k-th subspecies.
